(19) United States
(12) Patent Application Publication
(10) Pub. No.: US 2007/0167269 A1
(43) Pub. Date: Jul. 19, 2007

(54) Differential housing

(76) Inventor: Hideo Masuda, Aichi-ken (JP)

Correspondence Address: MORGAN & FINNEGAN, L.L.P., 3 World Financial Center, New York, NY, 10281-2101, US

(21) Appl. No.: 11/638,159

(22) Filed: Dec. 12, 2006

(30) Foreign Application Priority Data
Jan. 17, 2006 (JP) 2006-008782

(51) Int. Cl. F16H 48/06

(52) U.S. Cl. 475/220

(57) ABSTRACT

A differential housing includes: a housing main body having an opening and a breather hole, in which a ring gear is accommodated so that a part of the ring gear projects from the opening; and a housing cover closing the opening of the housing main body and having a recessed portion for accommodating a part of the ring gear projecting from the opening to the outside, the recessed portion of the housing cover being formed along a contour line of the part of the ring gear projecting from the opening of the housing main body to the outside.

### BACKGROUND OF THE INVENTION

1. Field of the Invention

The present invention relates to a differential housing, and more particularly, to a structure of the differential housing configured to prevent lubricating oil from leaking through a breather hole to the outside.

2. Description of the Related Art

Japanese Utility Model Application Laid-open No. 5-96613 discloses a conventional differential housing containing a ring gear. The differential housing has a breather hole communicating between the inside and the outside of the differential housing in order to suppress pressure fluctuation in the differential housing. A recessed portion is formed in an inclined ceiling portion of the differential housing, and the breather hole is formed in the recessed portion so that lubricating oil having scattered in the differential housing does not leak to the outside through the breather hole.

However, differential housings are usually made of castings. If the recessed portion is formed on the ceiling portion as in the description of Japanese Utility Model Application Laid-open No. 5-96613, a core in a casting mold is so complex in shape that there is a problem in that freedom of design decreases because a parting direction of the casting mold is limited.

### SUMMARY OF THE INVENTION

The present invention has been made in a view of solving the above-mentioned problem, and it is an object of the present invention to provide a differential housing in which it is possible to prevent leakage of lubricating oil through a breather hole to the outside without forming the breather hole in a recessed portion.

A differential housing according to the present invention includes: a housing main body having an opening and a breather hole, in which a ring gear is accommodated so that a part of the ring gear projects from the opening; and a housing cover closing the opening of the housing main body and having a recessed portion for accommodating a part of the ring gear projecting from the opening to the outside, and in the differential housing, the recessed portion of the housing cover being formed along a contour line of the part of the ring gear projecting from the opening of the housing main body to the outside.

Since the recessed portion on the housing cover is formed along the contour line of the part of the ring gear, the recessed portion regulates a direction in which lubricating oil is scattered due to a rotation of the ring gear. Thus, the recessed portion has a function of adjusting a flow direction of the lubricating oil.

### BRIEF DESCRIPTION OF THE DRAWINGS

FIG. 1 is a perspective view showing a differential housing according to a first embodiment of the present invention;

FIG. 2 is a plan view showing the differential housing according to the first embodiment;

FIG. 3 is a sectional plan view showing the differential housing according to the first embodiment;

FIG. 4 is a cross sectional view taken along the line A-A of FIG. 2;

FIG. 5 is a cross sectional view taken along the line B-B of FIG. 2; and

FIG. 6 is sectional front view showing a differential housing according to a second embodiment of the present invention.

### DESCRIPTION OF THE PREFERRED EMBODIMENTS

Embodiments of the present invention will be explained below with reference to the attached drawings.

### First Embodiment

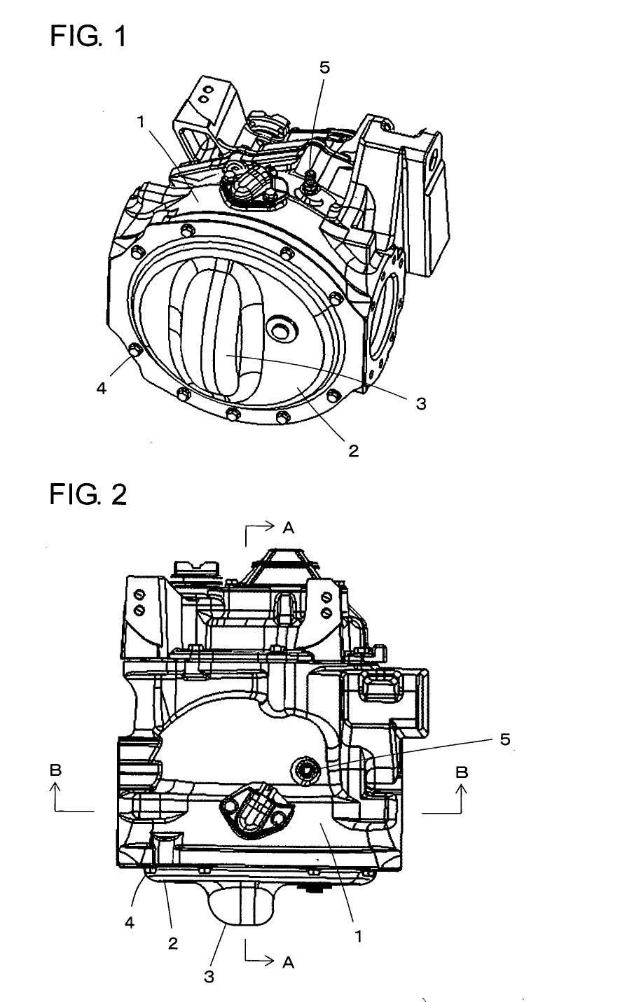

FIGS. 1 and 2 each show an overall view of a differential housing according to a first embodiment of the present invention. The differential housing comprises a housing main body 1 made of a casting and a housing cover 2 made of a sheet metal. The housing cover 2 formed in a disk shape includes, in a central part thereof, a cover gear portion 3 projecting outwardly, and is fixed to the housing main body 1 by a plurality of bolts 4. A breather hole (not shown) communicating between the inside and the outside of the housing main body 1 is formed in an upper section of the housing main body 1, and a breather valve 5 is attached to the breather hole.

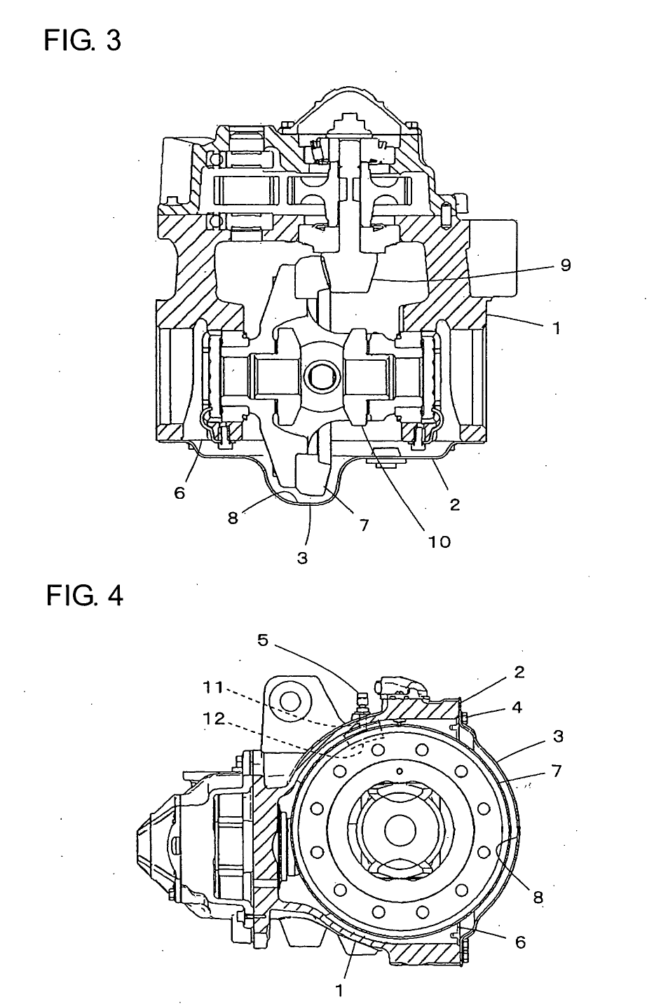

As shown in FIG. 3, an opening 6 is formed on a front end of the housing main body 1, and a ring gear 7 is contained in the housing main body 1 so that a part of the ring gear 7 projects from the opening 6 to the outside. A recessed portion 8, formed along a contour line of the part of the ring gear 7 projecting from the opening 6 to the outside, is formed on an inner surface of the cover gear portion 3 of the housing cover 2. The opening 6 of the housing main body 1 is closed by the housing cover 2.

FIG. 3 further shows a drive pinion 9 engaging with the ring gear 7, a differential gear 10 disposed coaxially with the ring gear 7, etc.

As shown in FIG. 4, the recessed portion 8 of the cover gear portion 3 of the housing cover 2 is formed along the contour line of the ring gear 7 also in a circumferential direction of the ring gear 7, and the inner surface of the cover gear portion 3 is disposed at an approximately constant interval from the ring gear 7.

An inner surface of the housing main body 1 is also formed along the contour line of ring gear 7 with respect to the circumferential direction of ring gear 7 and has an approximately constant interval from the ring gear 7 similarly to the cover gear portion 3.

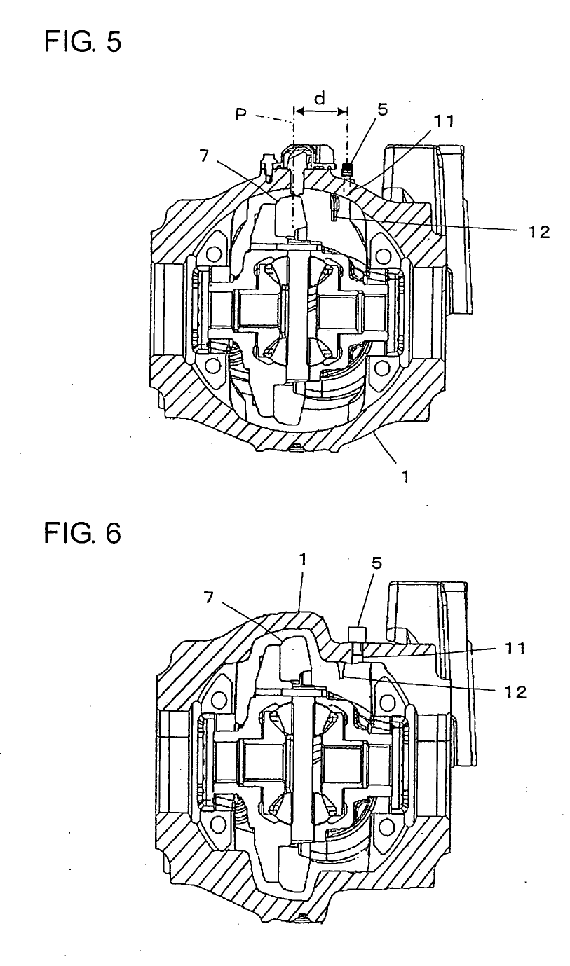

In addition, a partition plate 12 projecting downwardly is formed on a ceiling portion of the housing main body 1 disposed between a breather hole 11 and the ring gear 7 that are formed in the upper section of the housing main body 1. To be more specific, as shown in FIG. 5, the breather hole 11 is formed in a position offset from a rotation surface P of the ring gear 7 by a predetermined distance d in an axial direction of the ring gear 7, and the partition plate 12 is disposed between the breather hole 11 and the rotation surface P of the ring gear 7.

As shown in FIGS. 2, 4, and 5 specifically, a part of the housing main body 1 containing the ring gear 7 has a substantially spherical shape.

As explained above, since the recessed portion 8 of the cover gear portion 3 of the housing cover 2 is formed along the contour line of the ring gear 7 and has an approximately constant interval from the ring gear 7, a direction in which the lubricating oil is scattered due to the rotation of the ring gear 7 is controlled, so a flow-adjusting function occurs with respect to the lubricating oil.

Further, since the part of the housing main body 1 containing the ring gear 7 has an substantially spherical shape, and the inner surface of the housing main body 1 is formed along the contour line of ring gear 7 in the circumferential direction of ring gear 7 and has an approximately constant interval from the ring gear 7, the direction in which the lubricating oil is scattered due to the rotation of the ring gear 7 is controlled. In addition, the lubricating oil having flown from the housing cover 2 to the housing main body 1 further flows down along the inner surface of the housing main body 1 with the flow thereof being stable.

As a result, the lubricating oil hardly reaches the breather hole 11, which is offset from the rotation surface P of ring gear 7 by a predetermined distance d in the axial direction of the ring gear 7 and formed on the upper section of housing main body 1, so the leakage of lubricating oil to the outside of the differential housing through the breather valve 5 can be prevented effectively.

Further, since the partition plate 12 projecting downwardly is formed on the ceiling portion of the housing main body 1 disposed between the breather hole 11 and rotation surface P of the ring gear 7, the lubricating oil having scattered due to the rotation of the ring gear 7 and having flown along the ceiling portion of housing main body 1 is stemmed by the partition plate 12 and falls down from the partition plate 12, so the lubricating oil is prevented from flowing to the breather hole 11.

The effect obtained by the partition plate 12 for preventing the lubricating oil from infiltrating into the breather hole 11 becomes more significant in proportion with the length of the partition plate 12 in the circumferential direction of the ring gear 7.

Further, since the part of the housing main body 1 containing the ring gear 7 has an substantially spherical shape, the shape of a core in a casting mold used for casting operations becomes simple. Therefore, freedom in designing the casting mold increases with respect to a parting direction, manufacture of the differential housing is facilitated, and mechanical strength thereof increases.

### Second Embodiment

FIG. 6 is a sectional front view showing a differential housing according to a second embodiment of the present invention. In the second embodiment, the housing main body 1 does not have a spherical shape, and is formed along a contour line of the ring gear 7 both in a circumferential and in an axial direction of the ring gear 7 similarly to the recessed portion 8 of the cover gear portion 3 of the housing cover 2. The housing cover 2 used here is similar to that shown in the first embodiment.

When such the housing main body 1 is used, the function of adjusting the flow direction of the lubricating oil occurs in the housing main body 1 by making the shape of the housing main body 1 fit the shape of the housing cover 2, so the lubricating oil flows around the whole circumference of the ring gear 7 smoothly. Accordingly, the flow of the lubricating oil toward the breather hole 11 decreases, and the leakage of the lubricating oil to the outside of differential housing through the breather valve 5 is thus prevented.

Although the breather hole 11 is formed in the upper section in the housing main body 1 in the first and second embodiments, the present invention is not limited thereto, i.e., the breather hole 11 may be formed on a side section or the like of the housing main body 1.

According to the present invention, since the recessed portion of the housing cover has a function of adjusting the flow direction of the lubricating oil, it is possible to prevent the leakage of the lubricating oil from the breather hole without forming the breather hole in a recessed portion.

What is claimed is:

1. A differential housing, comprising:
a housing main body having an opening and a breather hole, in which a ring gear is accommodated so that a part of the ring gear projects from the opening; and
a housing cover closing the opening of the housing main body and having a recessed portion for accommodating a part of the ring gear projecting from the opening to the outside,
the recessed portion of the housing cover being formed along a contour line of the part of the ring gear projecting from the opening of the housing main body to the outside.

2. A differential housing according to claim 1, wherein the breather hole of the housing main body is formed at a position offset from a rotation surface of the ring gear by a predetermined distance in an axial direction of the ring gear.

3. A differential housing according to claim 2, wherein a partition plate is formed on and projects from an inner surface of the housing main body and between a rotation surface of the ring gear and the breather hole.

4. A differential housing according to claim 1, wherein the housing main body has an inner surface formed along the contour line of the ring gear in a circumferential direction of the ring gear.

5. A differential housing according to claim 4, wherein the part of the housing main body containing the ring gear has a substantially spherical shape.

6. A differential housing according to claim 4, wherein the housing main body has an inner surface formed along the contour line of the ring gear also in an axial direction of the ring gear.

7. A differential housing according to claim 1, wherein the recessed portion of the housing cover is formed along the contour line of the part of the ring gear both in a circumferential direction and in an axial direction of the ring gear.

8. A differential housing according to claim 7, wherein the recessed portion of the housing cover is disposed at an approximately constant interval from the ring gear.

9. A differential housing according to claim 1, further comprising a breather valve attached to the breather hole of the housing main body.
